(19) United States
(12) Patent Application Publication
(10) Pub. No.: US 2017/0145359 A1
(43) Pub. Date: May 25, 2017

(54) LIQUID LAUNDRY DETERGENT COMPOSITION COMPRISING A POLYMER SYSTEM

(71) Applicant: The Procter & Gamble Company, Cincinnati, OH (US)

(72) Inventors: Sammy Kibet SAMBU, STROMBEEK-BEVER (BE); Steven Jozef Louis COOSEMANS, KAMPENHOUT (BE); Jean-Francois BODET, WATERLOO (BE)

(21) Appl. No.: 15/341,258

(22) Filed: Nov. 2, 2016

(30) Foreign Application Priority Data
Nov. 19, 2015 (EP) 15195479.9
Oct. 7, 2016 (EP) 16192887.4

(51) Int. Cl. C11D 17/04; C11D 1/29; C11D 11/00; C11D 3/37; C11D 3/00; C11D 1/22; C11D 1/66

(52) U.S. Cl. CPC C11D 17/043; C11D 1/22; C11D 1/29; C11D 1/66; C11D 3/3707; C11D 3/3723; C11D 3/001; C11D 11/0017

(57) ABSTRACT

A liquid laundry detergent composition, water-soluble unit dose articles including the detergent compositions, and methods of using the detergent and unit dose article.

### FIELD OF THE INVENTION

The present disclosure is to liquid laundry detergent composition, water-soluble unit dose articles comprising the detergent compositions and methods of using the detergent and unit dose article.

### BACKGROUND OF THE INVENTION

Liquid laundry detergent compositions often comprise surfactants and cleaning polymers. These various actives provide cleaning benefit against certain stains or combinations of stains. However, oftentimes, the liquid laundry detergent composition will exhibit good cleaning benefit against some stains but exhibit reduced stain removal efficacy on combinations of stains and general particulate dirt.

Therefore, there is a need in the art for a liquid laundry detergent composition that provides excellent stain removal even in the presence of particulate dirt. It is especially desired for a liquid laundry detergent composition that provides excellent cleaning, specifically on hydrophobic stains in the presence of particulate dirt.

### SUMMARY OF THE INVENTION

The present disclosure relates to a liquid laundry detergent composition comprising:
Between 25% and 50% by weight of the composition of an anionic surfactant;
Between 1% and 20% by weight of the composition of water;
Between 1.75% and 10% by weight of the composition of a polymer system,
wherein the polymer system comprises a polyethylene glycol polymer and an ethoxylated polyethyleneimine polymer;
   and wherein the polymer system comprises between 30% and 100% by weight of the polymer system of the polyethylene glycol polymer.

The present disclosure also relates to a water-soluble unit dose article comprising a water-soluble film and a composition according to the present disclosure.

The present disclosure also relate to a method of laundering fabrics comprising the steps of:
adding the composition according to claim 1 or unit dose article according to claim 10 to a volume of water such that the composition is diluted in the water by a factor of at least 300 to form a wash liquor;
contacting the wash liquor with fabrics.

### DETAILED DESCRIPTION OF THE INVENTION

### Liquid Laundry Detergent Composition

The present invention is to a liquid laundry detergent composition. In relation to the laundry detergent composition of the present invention, the term ‘liquid’ encompasses forms in which solid material is present within the liquid composition such as dispersions, gels, pastes, slurries and the like. The liquid composition may also include gases in suitably subdivided form. However, the liquid composition excludes forms which are non-liquid overall, such as tablets or granules.

The term ‘liquid laundry detergent composition’ refers to any laundry detergent composition comprising a liquid capable of wetting and treating fabric e.g., cleaning clothing in a domestic washing machine. Liquid laundry detergent compositions including fabric care compositions that provide benefits such as softening ant-wrinkle benefit etc.

The liquid laundry detergent composition can be used as a fully formulated consumer product, or may be added to one or more further ingredient to form a fully formulated consumer product. The liquid laundry detergent composition may be a ‘pre-treat’ composition which is added to a fabric, preferably a fabric stain, ahead of the fabric being added to a wash liquor.

The liquid composition may be formulated into a unit dose article. The unit dose article of the present invention comprises a water-soluble film which fully encloses the liquid composition in at least one compartment. Water-soluble unit dose articles are described in more detail below.

The liquid laundry detergent composition comprises between 25% and 50% by weight of the composition of an anionic surfactant. The anionic surfactant is described in more detail below.

The liquid laundry detergent composition comprises between 1% and 20%, preferably between 1% and 15%, more preferably between 1% and 13.5% by weight of the composition of water.

The liquid laundry detergent composition comprises between 1.75% and 10% by weight of the composition of a polymer system, wherein the polymer system comprises a polyethylene glycol polymer and an ethoxylated polyethyleneimine polymer. Furthermore, the polymer system comprises between 30% and 100% by weight of the polymer system of the polyethylene glycol polymer. The polymer system is described in more detail below.

Without wishing to be bound by theory it is believed that it is the combination of the specific polymer system together with the anionic surfactant at the levels claimed that provides the benefit. Improved cleaning can be seen on a broad variety of claims, but especially on hydrophobic stains. Hydrophobic stains include oils, including vegetable oils, mineral oils and mixtures thereof. Furthermore, improved cleaning was seen on animal fat stains comprising particulate clays. Such stains are formed when animal fats are deposited onto fabrics and particulate clays found in the environment deposit onto the animal fat.

### Polymer System

The liquid laundry detergent composition comprises between 1.75% and 10%, preferably between 1.5% and 7%, more preferably between 2% and 5% by weight of the composition of a polymer system.

The polymer system comprises a polyethylene glycol polymer and an ethoxylated polyethyleneimine polymer. Furthermore, the polymer system comprises between 30% and 100%, preferably between 35% and 95%, more preferably between 40% and 85% by weight of the polymer system of the polyethylene glycol polymer.

Polyethylene glycol polymers are those which comprise a polyethylene glycol. Preferably, the polymer backbone comprises the polyethylene glycol and the backbone further comprises side-chains grafted onto said polyethylene glycol backbone. Most preferably, the polyethylene glycol polymer comprises a polyethylene glycol backbone and hydrophobic sidechains. Preferred hydrophobic sidechains are selected from polyvinyl acetate, polyvinyl alcohol and mixtures thereof. Preferably, the polymer comprises from 25% to 60% by weight of the polymer of the backbone.

Preferably, the ethoxylated polyethyleneimine has an average degree of ethoxylation of between 15 and 25. Preferably, the ethoxylated polyethyleneimine has an average molecular weight of between 1000 and 2000 daltons. The ethoxylated polyethyleneimine is a compound having 2 or more repeating monomer units forming a backbone. The ethoxylated polyethyleneimine is preferably such that the ethoxylate groups are not part of the backbone of the polymer, but are ethoxylation groups of the imine in the units forming the backbone, or are ethoxylate groups of other side-groups chemically bound to the backbone.

Preferably, the imine units are present as backbone of the polymer, forming the chain of repeating units. Preferably, these polymers have at least 3 or even 4 or even 5 imine units.

### Anionic Surfactant

The liquid laundry detergent composition comprises between 25% and 50%, preferably between 27% and 40%, more preferably between 30% and 35% by weight of the composition of an anionic surfactant.

Preferably, the anionic surfactant comprises linear alkylbenzene sulphonate, alkyl sulphate, alkoxylated alkyl sulphate or a mixture thereof.

Exemplary linear alkylbenzene sulphonates are C₁₀-C₁₆ alkyl benzene sulfonic acids, or C₁₁-C₁₄ alkyl benzene sulfonic acids. By ‘linear’, we herein mean the alkyl group is linear.

The alkoxylated alkyl sulphate anionic surfactant may be a C₁₀-C₁₈ alkyl ethoxy sulfate (AEₓS) wherein x is an average degree of ethoxylation of from 0.5 to 30, preferably between 1 and 10, more preferably between 1 and 5.

Anionic surfactants may comprise fatty acid. The anionic surfactant may comprise linear alkylbenzene sulphonate, alkyl sulphate, alkoxylated alkyl sulphate, fatty acid or a mixture thereof. The term ‘fatty acid’ includes fatty acid or fatty acid salts. The fatty acids are preferably carboxylic acids which are often with a long unbranched aliphatic tail, which is either saturated or unsaturated. Suitable fatty acids include ethoxylated fatty acids. Suitable fatty acids or salts of the fatty acids for the present invention are preferably sodium salts, preferably C12-C18 saturated and/or unsaturated fatty acids more preferably C12-C14 saturated and/or unsaturated fatty acids and alkali or alkali earth metal carbonates preferably sodium carbonate.

Preferably the fatty acids are selected from the group consisting of lauric acid, myristic acid, palmitic acid, stearic acid, topped palm kernel fatty acid, coconut fatty acid and mixtures thereof.

### Non-Ionic Surfactant

The liquid laundry detergent composition may comprise less than 10%, or even between 0.1% and less than 10%, preferably between 0.5% and 7.5%, more preferably between 1% and 5% by weight of the composition of a non-ionic surfactant.

Preferably, the non-ionic surfactant comprises a fatty alcohol alkoxylate, an oxo-synthesised fatty alcohol alkoxylate, Guerbet alcohol alkoxylates, alkyl phenol alcohol alkoxylates or a mixture thereof. The ethoxylated nonionic surfactant may be, e.g., primary and secondary alcohol ethoxylates, especially the C₈-C₂₀ aliphatic alcohols ethoxylated with an average of from 1 to 50 or even 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol.

The ethoxylated alcohol non-ionic surfactant can be, for example, a condensation product of from 3 to 8 mol of ethylene oxide with 1 mol of a primary alcohol having from 9 to 15 carbon atoms.

The non-ionic surfactant may comprise a fatty alcohol ethoxylate of formula R(EO)ₙ, wherein R represents an alkyl chain between 4 and 30 carbon atoms, (EO) represents one unit of ethylene oxide monomer and n has an average value between 0.5 and 20.

### Adjunct Ingredients

The liquid laundry detergent composition may comprise between 0.05% and 10% by weight of the composition of a brightener, a chelant or a mixture thereof.

The brightener is preferably selected from stilbene brighteners, hydrophobic brighteners and mixtures thereof.

The brightener may comprise stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

Suitable brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)];amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl. A suitable fluorescent brightener is C.I. Fluorescent Brightener 260, which may be used in its beta or alpha crystalline forms, or a mixture of these forms.

Suitable chelants may be selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof. A suitable chelant is ethylene diamine-N′N′-disuccinic acid (EDDS) and/or hydroxyethane diphosphonic acid (HEDP). The laundry detergent composition may comprise ethylene diamine-N′N′-disuccinic acid or salt thereof. The ethylene diamine-N′N′-disuccinic acid may be in S,S enantiomeric form. The composition may comprise 4,5-dihydroxy-m-benzenedisulfonic acid disodium salt, glutamic acid-N,N-diacetic acid (GLDA) and/or salts thereof, 2-hydroxypyridine-l-oxide, Trilon P™ available from BASF, Ludwigshafen, Germany.

Chelants may also be selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

### Water-Soluble Unit Dose Article

Another aspect of the present invention is a water-soluble unit dose article comprising a water-soluble film and the liquid laundry detergent composition of the present invention, preferably wherein the unit dose article comprises at least two compartments, or even at least three or even at least four compartments.

The water-soluble unit dose article comprises at least one water-soluble film shaped such that the unit-dose article comprises at least one internal compartment surrounded by the water-soluble film. The at least one compartment comprises the liquid laundry detergent composition. The water-soluble film is sealed such that the liquid laundry detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the composition. The unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the composition according to the present invention may be comprised in at least one of the compartments. It may for example be comprised in just one compartment, or may be comprised in two compartments, or even in three compartments.

Each compartment may comprise the same or different compositions. The different compositions could all be in the same form, for example they may all be liquid, or they may be in different forms, for example one or more may be liquid and one or more may be solid.

The water-soluble unit dose article may comprise an aversive agent within the water-soluble film, on the unit dose article, with the liquid laundry detergent composition or a mixture thereof.

The water-soluble unit dose article may comprise an air bubble.

The water-soluble unit dose article may be transparent, translucent or opaque.

The film of the present invention is soluble or dispersible in water.

The water-soluble film preferably has a thickness of from 20 to 200 microns, preferably 35 to 150 microns, even more preferably 50 to 125 microns, most preferably from 75 to 100 microns, or 76 microns, or 100 microns. Preferably, the water-soluble film prior to being made into a water-soluble unit dose article has a thickness between 20 μm and 200 μm, preferably between 35 μm and 150 μm, even more preferably between 50 μm and 125 μm, most preferably between 75 μm and 100 μm or 76 microns, or 100 microns. Herein we mean the thickness of the film before it has been subjected to any thermoforming, elastic strain or plasticization techniques such as thermoforming into a mould for example or stretching from general film handling.

Different film material and/or films of different thickness may be employed in making the compartments of the present invention. A benefit in selecting different films is that the resulting compartments may exhibit different solubility or release characteristics.

Preferred films exhibit good dissolution in cold water, meaning unheated distilled water. Preferably such films exhibit good dissolution at temperatures 24° C., even more preferably at 10° C. By good dissolution it is meant that the film exhibits water-solubility of at least 50%, preferably at least 75% or even at least 95%, as measured, by the method set out here after using a glass-filter with a maximum pore size of 20 microns, described below. Water-solubility may be determined at 24° C., or preferably at 10° C.

Dissolution Method: 50 grams ±0.1 gram of film material is added in a pre-weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion, or blown extrusion of the polymeric material, as known in the art. Preferably the film is obtained by an extrusion process or by a casting process.

Preferred polymers (including copolymers, terpolymers, or derivatives thereof) suitable for use as film material are selected from polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the polymers of the film material are free of carboxylate groups. Preferably, the level of polymer in the film material, for example a PVA polymer, is at least 60%. The polymer can have any weight average molecular weight, preferably from about 1000 to 1,000,000, more preferably from about 10,000 to 300,000, yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000 to about 40,000, preferably about 20,000, and of PVA or copolymer thereof, with a weight average molecular weight of about 100,000 to about 300,000, preferably about 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers, preferably polyvinyl alcohol, which are from about 60% to about 99% hydrolysed, preferably from about 80% to about 99% hydrolysed, even more preferably from about 80% to about 90% hydrolysed, to improve the dissolution characteristics of the material. Preferred films are those supplied by Monosol (Merrillville, Ind., USA) under the trade references M8630, M8900, M8779, M8310, M9467, and PVA films of corresponding solubility and deformability characteristics. Other suitable films may include called Solublon ® PT, Solublon ® GA, Solublon ® KC or Solublon ® KL from the Aicello Chemical Europe GmbH, the films VF-HP by Kuraray, or the films by Nippon Gohsei, such as Hi Selon. Suitable films include those supplied by Monosol for use in the following Procter and Gamble products: TIDE PODS, CASCADE ACTION PACS, CASCADE PLATINUM, CASCADE COMPLETE, ARIEL 3 IN 1 PODS, TIDE BOOST ORIGINAL DUO PACs, TIDE BOOST FEBREZE SPORT DUO PACS, TIDE BOOST VIVID WHITE BRIGHT PACS, DASH, FAIRY PLATINUM. It may be preferable to use a film that exhibits better dissolution than M8630 film, supplied by Monosol, at temperatures 24° C., even more preferably at 10° C.

Preferred water soluble films are those derived from a resin that comprises a blend of polymers, preferably wherein at least one polymer in the blend is polyvinyl alcohol. Preferably, the water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20 ° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons. Of the total PVA resin content in the film described herein, the PVA resin can comprise about 30 to about 85 wt% of the first PVA polymer, or about 45 to about 55 wt% of the first PVA polymer. For example, the PVA resin can contain about 50 w.% of each PVA polymer, wherein the viscosity of the first PVA polymer is about 13 cP and the viscosity of the second PVA polymer is about 23 cP.

The films may be water soluble copolymer films comprising a least one negatively modified monomer with the following formula:

[Y]-[G]ₙ

wherein Y represents a vinyl alcohol monomer and G represents a monomer comprising an anionic group and the index n is an integer of from 1 to 3. G can be any suitable comonomer capable of carrying of carrying the anionic group, for example G is a carboxylic acid. G may be selected from the group consisting of maleic acid, itaconic acid, coAMPS, acrylic acid, vinyl acetic acid, vinyl sulfonic acid, allyl sulfonic acid, ethylene sulfonic acid, 2 acrylamido 1 methyl propane sulfonic acid, 2 acrylamido 2 methyl propane sulfonic acid, 2 methyl acrylamido 2 methyl propane sulfonic acid, and mixtures thereof. Suitable films may include blends of such copolymers.

The anionic group of G may be preferably selected from the group consisting of OSO₃M, SO₃M, CO₂M, OCO₂M, OPO₃M₂, OPO₃HM and OPO₂M. More preferably, the anionic group of G is selected from the group consisting of OSO₃M, SO₃M, CO₂M, and OCO₂M. Most preferably the anionic group of G is selected from the group consisting of SO₃M and CO₂M. As used herein, M is a suitable counterion known to one of ordinary skill, such as hydrogen (H+), an alkali metal (e.g., Na⁺, K⁺), an alkali earth metal (1/2Ca²⁺), or ammonium (NH₄⁺). The film material herein can also comprise one or more additive ingredients. For example, the film preferably comprises a plasticizing agent. The plasticizing agent may comprise water, glycerol, ethylene glycol, diethylene glycol, propylene glycol, diproypylene glycol, sorbitol, or mixtures thereof. In some aspects, the film comprises from about 2% to about 35%, or from about 5% to about 25%, by weight of the film, a plasticizing agent selected from group comprising water, glycerol, diethylene glycol, sorbitol, and mixtures thereof. In some aspects, the film material comprises at least two, or preferably at least three, plasticizing agents. In some aspects, the film is substantially free of ethanol, meaning that the film comprises from 0% (including 0%) to about 0.1% ethanol by weight of the film. In some aspects, the plasticizing agents are the same as solvents found in an encapsulated liquid composition. Other additives may include water and functional detergent additives, including surfactant, to be delivered to the wash water, for example, organic polymeric dispersants, etc. Additionally, the film may comprise an aversive agent, further described herein.

The water-soluble unit dose article may comprise an area of print. The water-soluble unit dose article may be printed using flexographic techniques, ink jet printing techniques or a mixture thereof. The printed are may be on the film, preferably on the outside of the film, within the film, on the inside of the film or a mixture thereof. The printed area may convey information such as usage instructions, chemical safety instructions or a mixture thereof. Alternatively, the entire surface of the pouch, or substantially the entire surface of the pouch is printed in order to make the pouch opaque. The print may convey an image that reduces the risk of confusion and hence accidental ingestion of the pouch.

The water-soluble unit dose article may comprise an aversive agent. As used herein, an aversive agent is an agent that is intended to discourage ingestion and/or consumption of the unit dose articles described herein or components thereof, such as water-soluble films. An aversive agent may act by providing an unpleasant sensation, such as an unpleasant taste, when placed in the mouth or ingested. Such unpleasant sensations may include bitterness, pungency (or heat/spiciness), an unpleasant odor, sourness, coldness, and combinations thereof. An aversive agent may also act by causing humans and/or animals to vomit, for example via emetic agents.

Suitable aversive agents include bittering agents, pungent agents, emetic agents, and mixtures thereof.

The level of aversive agent used may be at least at an effective level, which causes the desired aversive effect, and may depend on the characteristics of the specific aversive agents, for example bitter value. The level used may also be at or below such a level that does not cause undesired transfer of the aversive agents to a human and/or animal, such as transfer to hands, eyes, skin, or other body parts. The aversive agent may be present at a concentration which elicits repulsive behavior within a maximum time of six seconds in cases of oral exposure.

The aversive agent may be selected from the group comprising naringin; sucrose octaacetate; denatonium benzoate; capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-rnethoxy-4′-hydroxy-phenyl)-1,3 -dioxolane ; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

### Method of Use

The present invention is also to a method of laundering fabrics comprising the steps of
Adding the composition according to the present invention or unit dose article according to the present invention to a volume of water such that the composition is diluted in the water by a factor of at least 300 to form a wash liquor;
Contacting the wash liquor with fabrics.

Preferably, the fabrics comprise a cationic fabric softening compound, i.e. a fabric softening compound that has been pre-deposited onto said fabrics.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### EXAMPLES

### Comparative Fabric Stain Removal Test

The ability of cleaning compositions to remove stains from fabrics were assessed. The stain removal is reported via a ‘stain removal index’ (SRI) and was evaluated by image analysis after a single wash. The index is drawn from the L-A-B color space measurements of fabric under standard illuminant conditions Daylight-65 (D65) as agreed by the “Commission International de I′Eclairage” (CIE) (this is the illumination of the midday sun in Northern Europe). The index is designed to be at 100% for complete removal and at 0% for no removal. The steps for assaying the whiteness maintenance of the laundry detergent composition of the present invention were as follows:
(1) Four (4) sample pretreatment compositions were prepared, which included: (Reference) a formulation used as a standard which is outside of the scope of the claims; (F1) a formulation within the scope of the claims; (F2) a formulation within the scope of the claims; and (F3) a formulation outside the scope of the claims. The detailed compositional breakdown of these compositions are listed below in Table 1:

TABLE 1

| Ingredient | REFERENCE | F1 | F2 | F3 |
|---|---|---|---|---|
| Linear alkylbenzene sulphonate | 14.55 | 20.75 | 17.23 | 14.55 |
| Alkoxylated alkyl sulphate | 7.90 | 14.70 | 16.09 | 2.00 |
| Non-ionic Surfactant | 12.77 | 6.68 | 7.96 | 12.77 |
| Chelant | 1.22 | 2.82 | 2.47 | 1.22 |
| polyethylene glycol polymer | 0.00 | 1.96 | 2.02 | 0.00 |
| ethoxylated polyethyleneimine | 1.00 | 2.30 | 1.13 | 3.90 |
| polymer | | | | |
| Builder | 0.61 | 1.46 | 1.52 | 0.61 |
| Fatty Acid | 14.70 | 12.09 | 9.37 | 5.70 |
| Optical Brightener | 0.21 | 0.21 | 0.28 | 0.21 |
| Protease | 0.06 | 0.06 | 0.06 | 0.06 |

(2) Preparation of water:
Into a 1 L beaker, prepare the “wash water” i.e. 0.067 g CaCl₂-2H₂O and 0.01 g

MgCl₂-6H₂O were added. To this 800 ml of deionized water was added. Using a stir bar and stirring plate, the solution was stirred until the mixture was dissolved and the solution turned clear. The solution was poured into a 1 L volumetric flask and filled to 1 L line with deionized water. The wash water was maintained at 20 degrees C. until use in step 9.
Prepare 2 ml of demineralized (free from mineral content) water to a 2 ml capacity well. The water will be used for rinsing and should be maintained at 20 degrees C. until use in step 9
(3) Test fabrics were selected from 0.5 cm diameter Burnt Butter Stains purchased from the Equest (UK).
(4) To a clean “wash well” of 2 ml capacity, one stained fabric was added.
(5) All solutions were diluted to the same dosage i.e. 505.98 ppm in the “wash water.” 0.95 ml of the diluted solution (“Reference”) was added into the 2 ml plastic chambers with fabrics; execute similarly for test solutions F1, F2 and F3.
   a. For derivation of deltaSRIBBU, a clean wash liquor is required, hence, no (0 ppm) of Arizona Dust was added with a maximum particle size set at 3 micrometers.
   b. For derivation of deltaSRIBBU EQ AZD, soiled wash liquor is required; hence, 4000 ppm of Arizona Dust was added with a maximum particle size set at 3 micrometers (i.e. stain in presence pof particulate dirt).
(6) The timer was started and the wash liquor pipetted for 15 minutes using a multipronged pipetting instrument.
(7) After the wash was complete, the wash liquor was aspirated
(8) Fresh rinsing water was added at 0.95 ml/sample and pipetted up and down for 4 complete cycles
(9) Fabrics were removed from wells and placed in a labeled well plate. The fabrics were spread out as much as possible. Samples were placed in a 40° C. oven overnight for drying.
(10) The color of the fabrics were measured using the DigiEye (VeriVide Limited, UK) with a D65 illumination
(11) The Stain Removal Index was calculated as follows:
dEᵢ: The straight line Euclidean distance between the unwashed stain and the unstained fabric
dE_{f}: The straight line Euclidean distance between the washed stain and the unstained fabric

$$dSRI = \frac{( {dE}_{f} - {dE}_{i} )}{{dE}_{i}} \times 100$$

The tolerance of the formulation towards the introduction of Arizona dust is calculated as follows:

Tolerance(delta)=deltaSRIBBU_{EQ}_{_{AZD}}−deltaSRIBBU

Results are shown in table 2;

TABLE 2

| Metric | REFERENCE | F1 | F2 | F3 |
|---|---|---|---|---|
| deltaSRIBBU | REF | 1.71 | 1.48 | −0.27 |
| deltaSRIBBU_EQ_AZD | REF | 4.42 | 4.06 | −1.40 |
| Tolerance (delta) | REF | 2.71 | 2.59 | −1.13 |

As can be seen from table 2, F1 and F2 exhibited excellent stain removal even in the presence of particulate dirt (Arizona dust). However, F3 exhibited poor stain removal.

Table 3 discloses two compositions, Examples 1 and 2 according to the present invention.

TABLE 3

| Ingredient (wt %) | Example 1 | Example 2 |
|---|---|---|
| 1,2-propanediol | 12.0 | 14.0 |
| dipropyleneglycol | 4.0 | 5.0 |
| glycerol | 4.0 | 5.0 |
| Water | 10.0 | 11.0 |
| Monethanolamine | 10.4 | 10.4 |
| Linear alkylbenzene sulphonic acid | 22.1 | 20 |
| C12-14EO3S anionic surfactant | 15.0 | 13 |
| C12-14EO7 nonionic surfactant | 3.9 | 4.0 |
| Top palm kernel Fatty Acid | 6.1 | 5.9 |
| Citric acid | 0.7 | 0.8 |
| Ethoxylated polyethyleneimine (PEI600EO20*) | 3.3 | 2.0 |
| Amphiphilic graft copolymer (PEG-Vinyl | 2.6 | 2.5 |
| acetate**) | | |
| Hydroxyethyldiphosphonic acid | 2.3 | 2.5 |
| Brightener 49 | 0.4 | 0.5 |
| Hydrogenated Castor Oil | 0.1 | 0.1 |
| MgCl2 | 0.3 | 0.3 |
| Minors (perfume, dye, suds suppressor, enzyme, | Balance | Balance |
| antioxidant) | | |

*ethoxylated polyethyleneimine having an average degree of ethoxylation of 20 per EO chain and a polyethyleneimine backbone with MW of about 600
**polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising:
between about 25% and about 50% by weight of the composition of an anionic surfactant;
between about 1% and about 20% by weight of the composition of water;
between about 1.75% and about 10% by weight of the composition of a polymer system, wherein the polymer system comprises a polyethylene glycol polymer and an ethoxylated polyethyleneimine polymer;
and wherein the polymer system comprises between about 30% and about 100% by weight of the polymer system of the polyethylene glycol polymer.

2. The liquid laundry detergent composition according to claim 1 comprising between about 1.5% and about 7%, by weight of the composition of the polymer system.

3. The liquid laundry detergent composition according to claim 2 comprising between about 2% and about 5% by weight of the composition of the polymer system.

4. The liquid laundry detergent composition according to claim 1 wherein the polymer system comprises between about 35% and about 95% by weight of the polymer system of the polyethylene glycol polymer.

5. The liquid laundry detergent composition according to claim 4 wherein the polymer system comprises between about 40% and about 85% by weight of the polymer system of the polyethylene glycol polymer.

6. The liquid laundry detergent composition according to claim 1 wherein the polyethylene glycol polymer comprises a polyethylene glycol backbone and hydrophobic sidechains.

7. The liquid laundry detergent composition according to claims 6 wherein the polymer comprises from about 25% to about 60% by weight of the polymer of the backbone.

8. The liquid laundry detergent composition according to claim 6, wherein the sidechains comprise polyvinyl acetate.

9. The liquid laundry detergent composition according to claim 1 wherein the ethoxylated polyethyleneimine has an average degree of ethoxylation of between about 15 and about 25.

10. The liquid laundry detergent composition according to claim 1, wherein the anionic surfactant comprises linear alkylbenzene sulphonate, alkyl sulphate, alkoxylated alkyl sulphate or a mixture thereof.

11. The liquid laundry detergent composition according to claim 1 comprising between about 27% and about 40%, by weight of the composition of anionic surfactant.

12. The liquid laundry detergent composition according to claim 11 comprising between about 30% and about 35% by weight of the composition of anionic surfactant.

13. The liquid laundry detergent composition according to claim 1 comprising between about 0.05% and about 10% by weight of the composition of a brightener, a chelant or a mixture thereof.

14. The liquid laundry detergent composition according to claim 1 comprising less than about 10%, by weight of the composition of a non-ionic surfactant.

15. The liquid laundry detergent composition according to claim 14 comprising between about 0.1% and less than about 10%, by weight of the composition of a non-ionic surfactant.

16. The liquid laundry detergent composition according to claim 15 comprising between about 0.5% and about 7.5%, by weight of the composition of a non-ionic surfactant.

17. The liquid laundry detergent composition according to claim 16 comprising between about 1% and about 5% by weight of the composition of a non-ionic surfactant.

18. A water-soluble unit dose article comprising a water-soluble film and a composition according to claim 1.

19. A method of laundering fabrics comprising the steps of
adding the composition according to claim 1 to a volume of water such that the composition is diluted in the water by a factor of at least 300 to form a wash liquor;
contacting the wash liquor with fabrics.

20. The method according to claim 19, wherein the fabrics comprise a cationic fabric softening compound.

21. The method according to claim 19, wherein the composition is in the form of a unit dose article.
